(19) United States
(12) Patent Application Publication
(10) Pub. No.: US 2012/0075972 A1
(43) Pub. Date: Mar. 29, 2012

(54) ELECTRON BEAM IRRADIATING APPARATUS AND LITHOGRAPHY METHOD

(75) Inventor: Takeshi OKINO, Yokohama-shi (JP)

(73) Assignee: KABUSHIKI KAISHA TOSHIBA, Tokyo (JP)

(21) Appl. No.: 13/053,877

(22) Filed: Mar. 22, 2011

(30) Foreign Application Priority Data
Sep. 28, 2010 (JP) 2010-217597

(51) Int. Cl. G11B 20/16

(52) U.S. Cl. 369/47.28; G9B/20.045

(57) ABSTRACT

An electron beam irradiating apparatus according to an embodiment includes: a deflector configured to perform blanking or deflecting of the electron beam emitted from an electron gun, the blanking being performed based on a blanking control signal, the deflecting being performed based on a deflection control signal, or blanking and deflecting being performed based on the blanking control signal and the deflection control signal; a first clock signal generation circuit configured to generate a first reference clock signal having cycles which vary with a drawing radial position on the stage; a second clock signal generation circuit configured to generate a second reference clock signal having cycles which are independent of the first reference clock signal; and a control signal generation circuit configured to generate a first control signal that is at least one of the blanking control signal and the deflection control signal, based on the first reference clock signal and the second reference clock signal.

### CROSS-REFERENCE TO RELATED APPLICATION

This application is based upon and claims the benefit of priority from prior Japanese Patent Application No. 2010-217597 filed on Sep. 28, 2010 in Japan, the entire contents of which are incorporated herein by reference.

### FIELD

Embodiments described herein relate generally to an electron beam irradiating apparatus and an electron beam irradiating method.

### BACKGROUND

In a technological trend toward higher-density magnetic disks (hereinafter also referred to as hard disks), media each having a structure of a so-called discrete track type have been suggested. In such a structure, magnetic regions that generate magnetic signals are partitioned by nonmagnetic regions. Further, bit-patterned media in which data track regions are partitioned not only by grooves in the circumferential direction but also by respective data bits have been suggested. A method of forming and processing dots by utilizing self-organization of a block copolymer has also been suggested. However, controlling alignment of dots in an orderly manner is considered difficult, particularly in a wide area. To counter this problem, a method that involves guide dots and a method that involves formation of respective dot patterns by electron beam irradiating have been suggested.

When a pattern for magnetic disks is drawn by electron beam irradiating, an electron beam irradiating apparatus including a movement mechanism for a horizontal direction and a rotation mechanism is normally used. To fix the exposure amount per unit area to a certain amount, drawing is performed with an electron beam at a constant linear velocity. In doing so, a write clock to be the reference for the timing of exposure is used at the signal source (also called formatter). The write clock becomes shorter in inner circumferences, and becomes longer in outer circumferences, so as to fix the number of clocks during rotations and vary the cycles with the radius. At such a signal source, there are no problems in a case where the number of sectors at least in a zone and the numbers of bits in the respective sectors are the same, or where drawing is performed in data regions of a discrete track type that do not require a fixed number of bits in the data regions by electron beam irradiating.

However, the write clock cannot cope with a case where bit patterns of data regions are to be formed at constant bit pitch in the circumferential direction, regardless of the radius, in a bit-patterned medium on which patterns corresponding to respective bits are to be formed by electron beam irradiating, and a case where patterns to be the core of the alignment of a self-organized polymer are to be formed at constant bit pitch in the circumferential direction, regardless of the radius, by electron beam irradiating in a bit-patterned medium having the patterns corresponding to the respective bits are basically formed through alignment of a self-organized polymer.

In a hard disk drive, recording or reproducing is normally performed while a medium is rotating at a constant rotational speed, and therefore, the servo regions are preferably formed with patterns at a constant angle, regardless of the radius. However, to obtain a higher recording density, the data regions are preferably formed with patterns at constant intervals, regardless of the radius, at least in a zone having a width in a radial direction.

### BRIEF DESCRIPTION OF THE DRAWINGS

FIG. 1 is a diagram showing an electron beam irradiating apparatus according to a first embodiment;

FIG. 2 is a diagram showing the upper face of a magnetic disk;

FIG. 3 is a waveform chart showing first and second reference clock signals in the first embodiment;

FIG. 4 is a diagram for explaining a situation where clock signal generation circuits are synchronized in the first embodiment;

FIG. 5 is a waveform chart showing an example case where synchronizing with the second reference clock signal is performed based on the first reference clock signal;

FIG. 6 is a flowchart showing the procedures to be carried out in an example case where synchronizing with the second reference clock signal is performed based on the first reference clock signal;

FIG. 7 is a diagram for explaining the waveform of a clock signal;

FIG. 8 is a waveform chart showing an example case where synchronizing is performed with the use of a determination signal generated based on the first reference clock signal;

FIG. 9 is a flowchart showing the procedures to be carried out in an example case where synchronizing is performed with the use of the determination signal generated based on the first reference clock signal;

FIG. 10 is a flowchart showing the procedures to be carried out in an example case where a check is made to determine whether the determination signal is in an ON state;

FIG. 11 is a waveform chart showing examples of the first and second reference clock signals to be used in a case where patterns corresponding to arm trajectories are to be drawn;

FIGS. 12(a) through 12(f) are cross-sectional views for explaining a method of manufacturing a magnetic recording medium according to a third embodiment;

FIGS. 13(a) through 13(f) are cross-sectional views for explaining a method of manufacturing a magnetic recording medium according to the third embodiment;

FIG. 14 is a perspective view of a magnetic recording/reproducing device according to a fourth embodiment;

FIG. 15 is a perspective view of a magnetic head assembly in the magnetic recording/reproducing device according to the fourth embodiment; and

FIGS. 16(a) through 16(d) are cross-sectional views for showing a method of manufacturing a magnetic recording medium according to an example 2.

### DETAILED DESCRIPTION

An electron beam irradiating apparatus according to an embodiment includes: a rotation mechanism configured to rotate a stage which holds a substrate, a photosensitive resin film being formed; a movement mechanism configured to move the stage in a horizontal direction; an electron gun configured to emit an electron beam onto the photosensitive resin film; a deflector configured to perform blanking or deflecting of the electron beam emitted from the electron gun, the blanking being performed based on a blanking control signal, the deflecting being performed based on a deflection control signal, or blanking and deflecting being performed based on the blanking control signal and the deflection control signal; a first clock signal generation circuit configured to generate a first reference clock signal having cycles which vary with a drawing radial position on the stage; a second clock signal generation circuit configured to generate a second reference clock signal having cycles independent of the first reference clock signal; and a control signal generation circuit configured to generate a first control signal that is at least one of the blanking control signal and the deflection control signal, based on the first reference clock signal and the second reference clock signal.

### First Embodiment

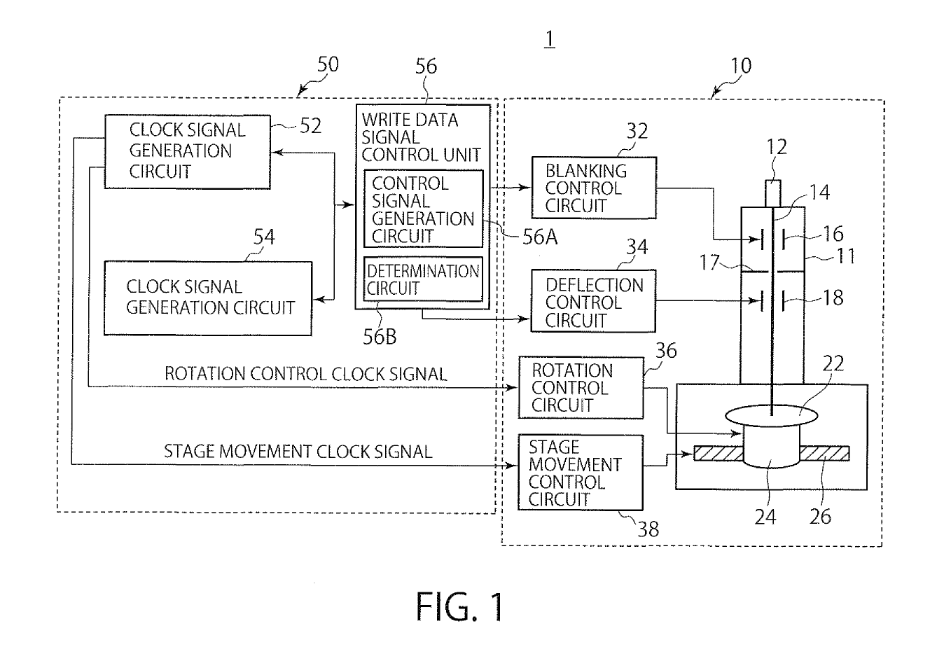

FIG. 1 illustrates an electron beam irradiating apparatus (hereinafter also referred to as an EBR (Electron Beam Recorder)) according to a first embodiment. The electron beam irradiating apparatus 1 includes an electron beam irradiating unit 10 and a control signal generation unit 50. The electron beam irradiating unit 10 includes: a lens tube 11; an electron gun 12 that emits an electron beam 14 into the lens tube 11; a blanking electrode 16 that is placed inside the lens tube 11 and passes or blanks the electron beam 14 emitted from the electron gun 12; an aperture 17 that blocks the electron beam 14 at the time of blanking, and passes the electron beam 14 when blanking is not performed; a deflector 18 that is placed inside the lens tube 11 and deflects the electron beam 14; a stage 22 which holds a substrate, a photosensitive resin film being formed to serve as an original plate with patterns being drawn on the film; a rotation mechanism 24 that rotates the stage 22; a movement mechanism 26 that moves the stage 22 in a horizontal direction; a blanking control circuit 32 that controls the blanking performed by the blanking electrode 16; a deflection control circuit 34 that controls the deflection performed by the deflector 18; a rotation control mechanism 36 that controls the rotation mechanism 24; and a stage movement mechanism 38 that controls the movement of the stage 22. Here, “moving the stage 22 in a horizontal direction” means moving the stage 22 in a direction parallel to the upper face of the stage 22.

The control signal generation unit 50 includes a clock signal generation circuit 52, a clock signal generation circuit 54, and a write data signal control unit 56. The write data signal control unit includes a control signal generation circuit 56A and a determination circuit 56B. The clock signal generation circuit 52 generates a first reference lock signal, and based on the first reference clock signal, also generates a rotation control clock signal for controlling the rotation mechanism 24 and a stage movement control clock signal for controlling the movement of the stage 22.

The clock signal generation circuit 54 generates a second reference clock signal having cycles which are independent of the cycles of the first reference clock signal. In the timing based on the first reference clock signal generated from the clock signal generation circuit 52 and the second reference clock signal generated from the clock signal generation circuit 54, the control signal generation circuit 56A generates a write data signal as a control signal for at least either a blanking control signal or a deflection control signal, based on the data about the patterns to be drawn. Based on the blanking control signal, the blanking control circuit 32 controls the blanking performed by the blanking electrode 16. Based on the deflection control signal, the deflection control circuit 34 controls the deflection performed by the deflector 18.

A magnetic recording medium (a magnetic disk) manufactured with the use of the original plate with patterns drawn thereon by the electron beam irradiating apparatus 1 of this embodiment normally includes several data regions or four data regions d1 through d4, for example, and servo regions s1 through s4 placed between the respective data regions d1 through d4, as shown in FIG. 2. FIG. 2 is a diagram showing the upper face of a specific example of such a magnetic disk. Each of the data regions d1 through d4 includes tracks tr formed by data bit patterns arranged in the circumferential direction. In FIG. 2, the servo regions s1 through s4 are formed in arc-like shapes along the trajectories of the arm of the magnetic disk device. Normally, in a magnetic disk device that drives a magnetic disk, recording and reproduction are performed with a magnetic head attached to the top end of the arm, and therefore, the pattern shapes of the magnetic disk are curved in accordance with the trajectories of the arm. To form such patterns, the reference drawing angular position needs to be varied for each radius by the amount equivalent to the arm trajectories when drawing is performed with the electron beam irradiating apparatus. In the magnetic disk, the data regions are arranged in the circumferential direction, and the servo regions for controlling positions are arranged across the respective tracks. Each of the servo regions includes regions such as a preamble region, an address region, and a burst region. In addition to those regions, each servo region can include a gap region. Sector number information that varies in the circumferential direction and track number information that varies in radial direction are arranged in the address region.

In the electron beam irradiating apparatus 1 of this embodiment, a mechanism that moves the stage 22 continuously in a horizontal direction is preferable to a mechanism that repetitively stops and moves the stage 22 for respective movement ranges in a horizontal direction as the movement mechanism 26 that moves the stage 22 in a horizontal direction, in view of pattern joining accuracy.

If electron beam exposure is performed by emitting a spot beam from a point on the movement axis in a horizontal direction onto the photosensitive resin on the substrate placed on the stage 22 in the electron beam irradiating apparatus 1, a spiral pattern is drawn, since the distance between the center of rotation of the substrate and the exposure position of the electron beam becomes longer with time unless the electron beam is not subjected to any external force and is not deflected.

To avoid that, the electron beam is deflected while the degree of deflection is gradually changed for each rotation in the electron beam exposure process. In this manner, concentric circles can be drawn. Here, one track is not necessarily drawn through one rotation, but one track can be formed by performing drawing through two or more rotations. By doing so, the patterning accuracy in the radial direction can be made higher.

To fix the exposure amount per unit area to a certain amount at the time of drawing, the stage needs to be rotated at a constant linear velocity. The amount of current of the electron beam in an electron beam irradiating apparatus that draws hard disk patterns of submicron order should be range from several nanoamperes to several tens of nanoamperes, in view of mass production and higher patterning accuracy.

In a case where a pattern in a circumferential direction is to be drawn with a blanking signal in an electron beam irradiating apparatus, the pattern can be drawn by switching the electron beam to an ON state or an OFF state by the amount equivalent to the desired length. However, in a case where a pattern in a radial direction is to be drawn, the beam needs to be switched to an ON state or an OFF state at a predetermined angular position in each rotation. A pattern can be formed by emitting an electron beam onto a desired drawing region with the use of a blanking signal and deflection. Alternatively, a pattern can be formed by emitting an electron beam onto a desired drawing region by reflection without a blanking signal.

Referring back to FIG. 1, the cycles of the first reference clock signal at the clock signal generation circuit 52 of this embodiment depend on the drawing radial position and the linear velocity of rotations as in conventional cases. Based on the first reference clock signal, the control signal generation circuit 56A generates the write data signal as the blanking control signal for switching the electron beam 14 on and off and/or the deflection control signal that reflects the time to deflect the electron beam 14 and corresponds to the pattern to be drawn.

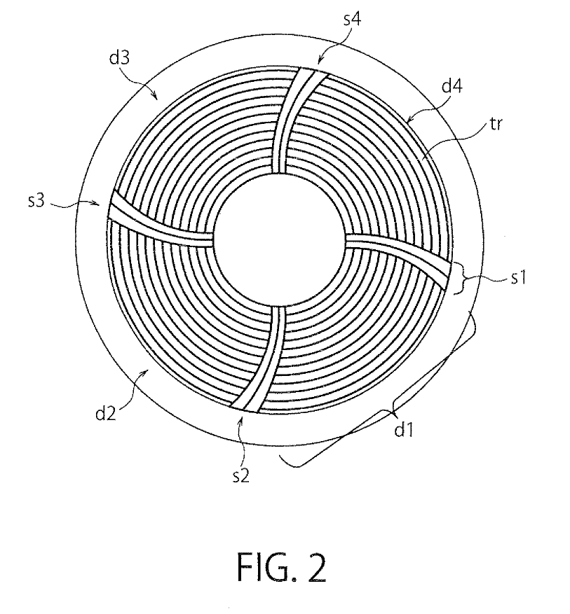

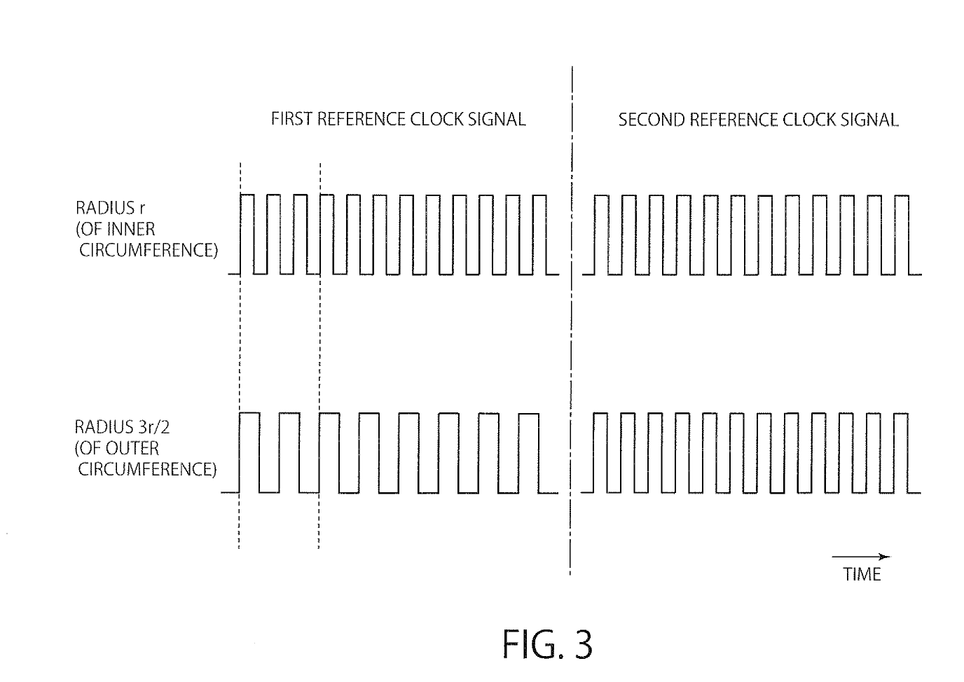

On the other hand, the second reference clock signal at the clock signal generation circuit 54 has cycles which are independent of the cycles of the first reference clock signal of the clock signal generation circuit 52. The second reference clock signal does not continuously vary at least with the drawing radial position, but has constant cycles at least in a certain radial region (within a zone). For example, the first and second reference clock signals in the cases of a radius r and a radius 3r/2 are as shown in FIG. 3.

Here, based on the first reference clock signal from the clock signal generation circuit 52, the control signal generation circuit 56A outputs a write data signal that is at least one of the deflection control signal and the blanking control signal for patterns in the servo regions. Based on the second reference clock signal from the clock signal generation circuit 54, the control signal generation circuit 56A outputs a write data signal that is at least one of the deflection control signal and the blanking control signal for patterns in the data regions. In this manner, patterns with circumferential lengths varying with the radius can be formed in the servo regions, and patterns having constant cycles (densities) that do not depend on the radius can be formed in the data regions.

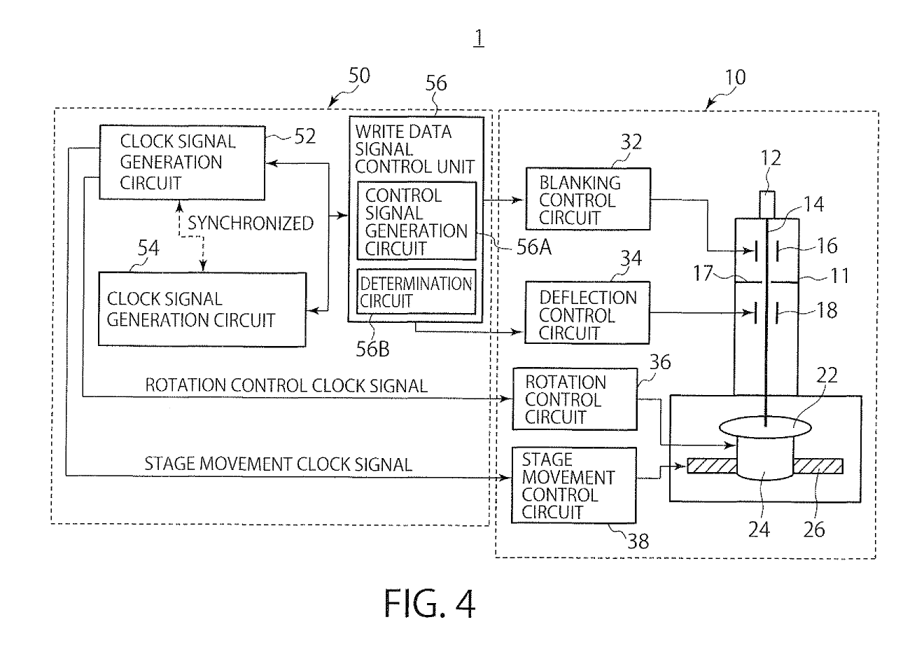

Further, as shown in FIG. 4, the clock signal generation circuit 52 and the clock signal generation circuit 54 are synchronized. For example, based on the first reference clock signal, a write data signal generated based on the second reference clock signal is output from the control signal generation circuit 56A for a predetermined period of time, or, based on the second reference clock signal, a write data signal generated based on the first reference clock signal is output from the control signal generation circuit 56A for a predetermined period of time. In this manner, patterns drawn with the write data signal generated based on the output signal of the clock signal generation circuit 52 and patterns drawn with the write data signal generated based on the output signal of the clock signal generation circuit 54 can be prevented from being misaligned or overlapping with each other due to an angular position.

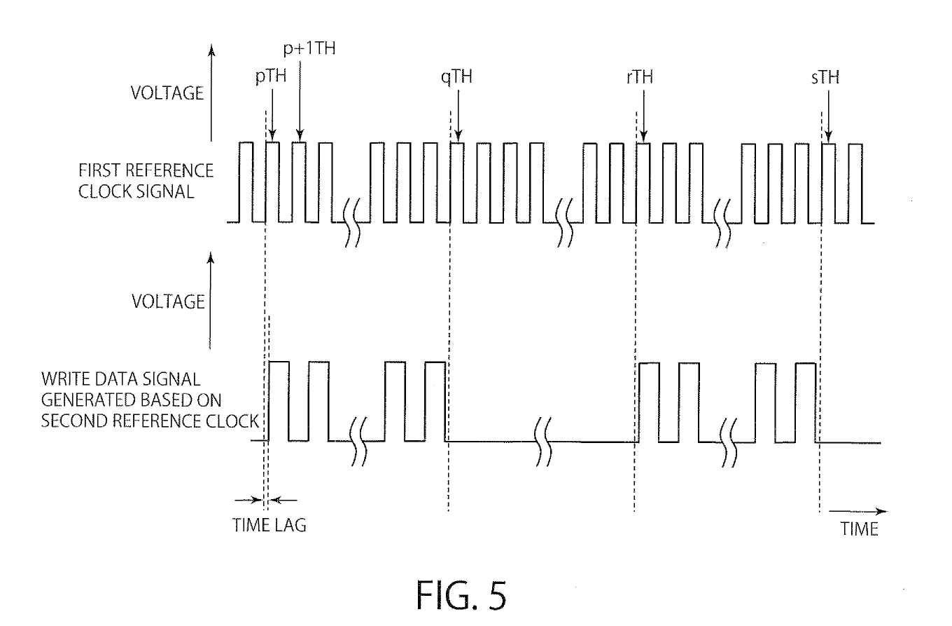

To perform the synchronizing, the write data signal generated based on the second reference clock signal is output from the control signal generation circuit 56A when the pth rising edge of the first reference clock signal counted from a reference point in a rotation is recognized, as shown in FIG. 5. The outputting of the write data signal generated based on the second reference clock signal from the control signal generation circuit 56A is stopped when the qth rising edge of the first reference clock signal is recognized. The outputting of the write data signal generated based on the second reference clock signal is suspended until the rth rising edge of the first reference clock signal. The write data signal generated based on the second reference clock signal is output from the control signal generation circuit 56A when the rth rising edge of the first reference clock signal is recognized, and the outputting of the write data signal generated based on the second reference clock signal from the control signal generation circuit 56A is stopped when the sth rising edge of the first reference clock signal is recognized. Here, if there is a delay due to the circuit or the design during the time between the recognition of a rising edge of the first reference clock signal and a start of outputting of the write data signal generated based on the second reference clock signal from the control signal generation circuit 56A, no problems will be caused as long as the misalignment due to the delay can be ignored or corrected in operations of a magnetic recording device. Actually, it is hard to perform an operation without a delay. Also, synchronizing can be performed, with the clock signal generation circuit 52 and the clock signal generation circuit 54 being replaced with each other. However, a signal that is output from the clock signal generation circuit 52 is used as a reference signal, as the number of clocks (or the order of clocks) of the reference signal does not vary with the radius. Alternatively, instead of a rising edge, a trailing edge can be used as a reference. Also, the reference signal on which synchronizing is based does not need to be a reference clock signal, a signal that is output from the control signal generation circuit 56A may be a reference signal. In that case, such a signal has constant cycles like the blanking control signal used for drawing preamble regions, and further preferably appears in each rotation. Other than that, based on a clock signal that is output from a third clock signal generation circuit, instead of the clock signal generation circuit 52 and the clock signal generation circuit 54, the control signal generation circuit 56A can output a write data signal generated based on the first reference clock signal of the clock signal generation circuit 52 and the write data signal generated based on the second reference clock signal of the clock signal generation circuit 54.

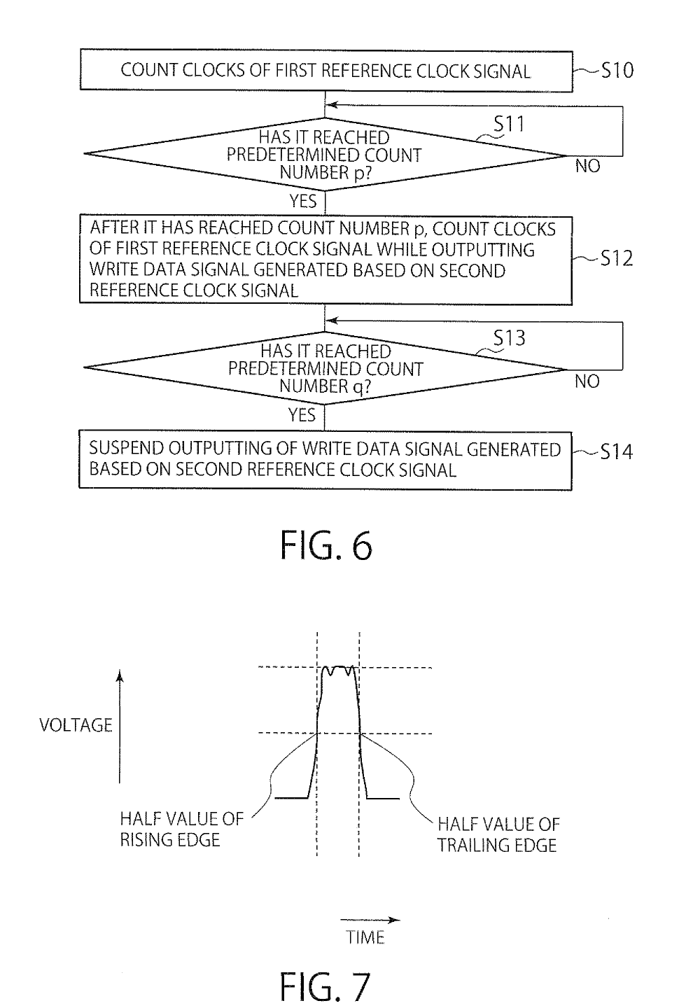

Referring now to the flowchart shown in FIG. 6, an example of the synchronizing is described. In this example of the synchronizing, clocks of the first reference clock signal are counted from a reference point in a rotation (step S10 of FIG. 6), and a check is made to determine whether the count value has reached a predetermined count number p (step S11 of FIG. 6) or not. If the count value has not reached the count number p, a count operation is continued. If the count value has reached the count number p, the clocks of the first reference clock signal are counted while the write data signal generated based on the second reference clock signal is output from the control signal generation circuit 56A (step S12 of FIG. 6). A check is then made to determine whether the count value has reached a predetermined count number q (step S13 of FIG. 6) or not. If the count value has not reached the count number q, the count operation is continued. If the count value has reached the count number q, the outputting of the write data signal generated based on the second reference clock signal is suspended (step S14 of FIG. 6). It should be noted that the count operation is performed at the determination circuit 56B.

The signals to be the references for the synchronization, such as a reference clock signal and a blanking signal, ideally have square waveforms as shown in FIG. 7. In reality, however, such a signal has a pulse-like portion in a square shape as shown in FIG. 7. Therefore, it is preferable to set a reference point at the point where the half value of a rising edge or the half value of a trailing edge is recognized.

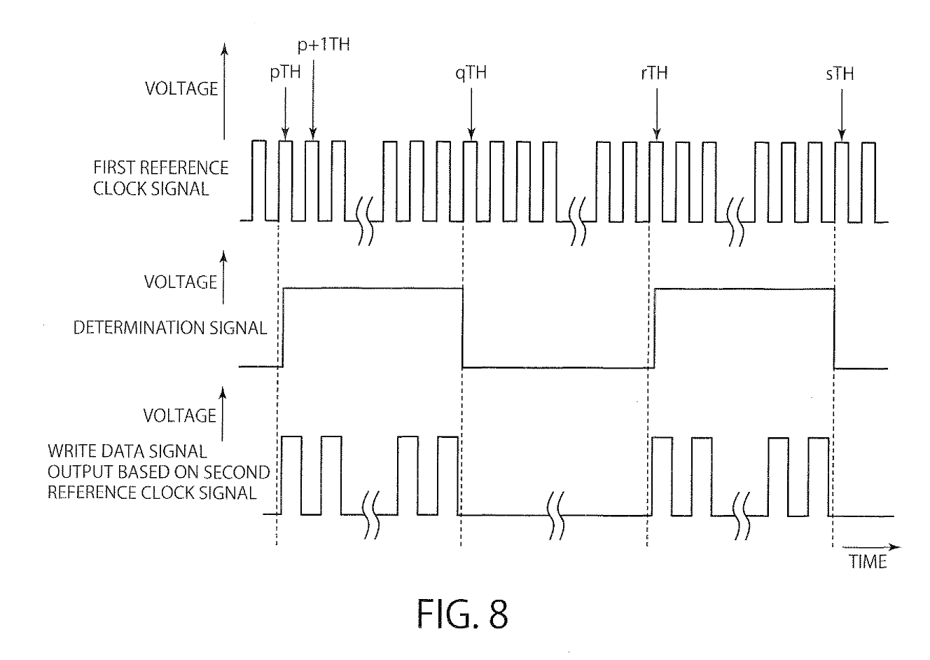

To perform the synchronizing, the first reference clock signal is not used as shown in FIG. 5, but a determination signal created at the determination circuit 56B based on the first reference clock signal can be used as shown in FIG. 8. With the use of such a determination signal, a control operation can be performed as follows. When the determination signal output is equal to or higher than a predetermined voltage, a write data signal generated based on the second reference clock signal from the clock signal generation circuit 54 is output. When the determination signal output is lower than the predetermined voltage, a write data signal generated based on the second reference clock signal from the clock signal generation circuit 54 is not output.

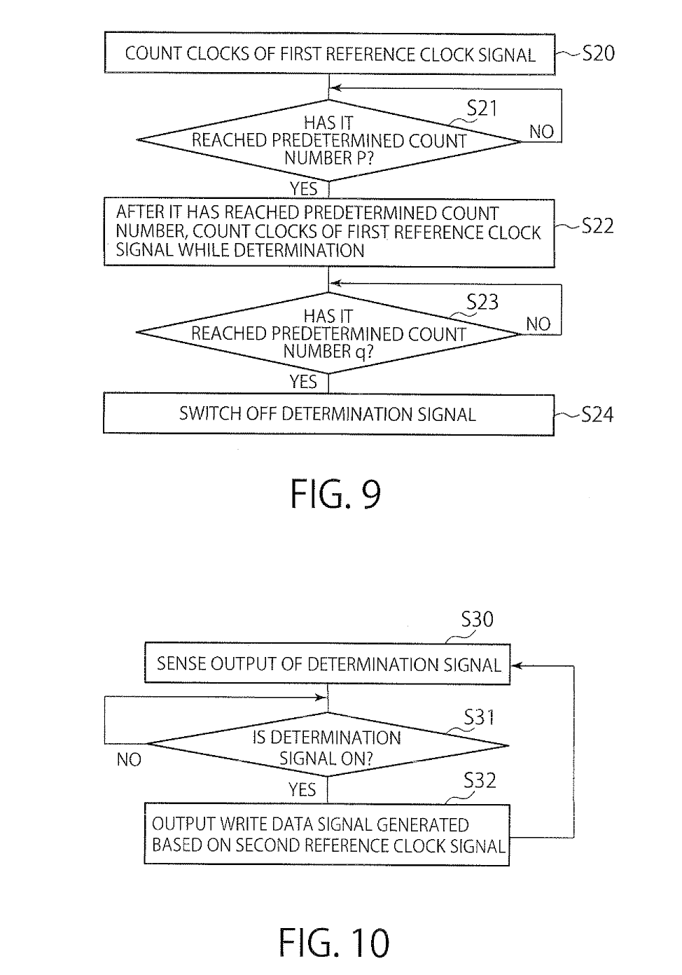

Referring now to the flowchart shown in FIG. 9, an example of the synchronizing in this case is described. To perform the synchronizing in this example case, for example, the clocks of the first reference clock signal are counted from a reference point in a rotation (step S20 of FIG. 9), and a check is made to determine whether the count value has reached the predetermined count number p (step S21 of FIG. 9) or not. If the count value has not reached the count number p, the count operation is continued. If the count value has reached the count number p, the clocks of the first reference clock signal are counted while the determination signal is being switched on (step S22 of FIG. 9). A check is then made to determine whether the count value has reached the predetermined count number q (step S23 of FIG. 9) or not. If the count value has not reached the count number q, the count operation is continued. If the count value has reached the count number q, the determination signal is switched off (step S24 of FIG. 9). The count operation is performed at the determination circuit 56B. When the determination signal is in an ON state, the write data signal generated based on the second reference clock signal is output from the control signal generation circuit 56A. To cause the control signal generation circuit 56A to output the write data signal generated based on the second reference clock signal, a check needs to be made to determine whether the determination signal is in an ON state or not, as shown in FIG. 10. An output of the determination signal is sensed (S30 of FIG. 10), and a check is made to determine whether the determination signal is in an ON state (step S31 of FIG. 10) or not. When the determination signal is in an ON state, the control signal generation circuit 56A is caused to output the write data signal generated based on the second reference clock signal.

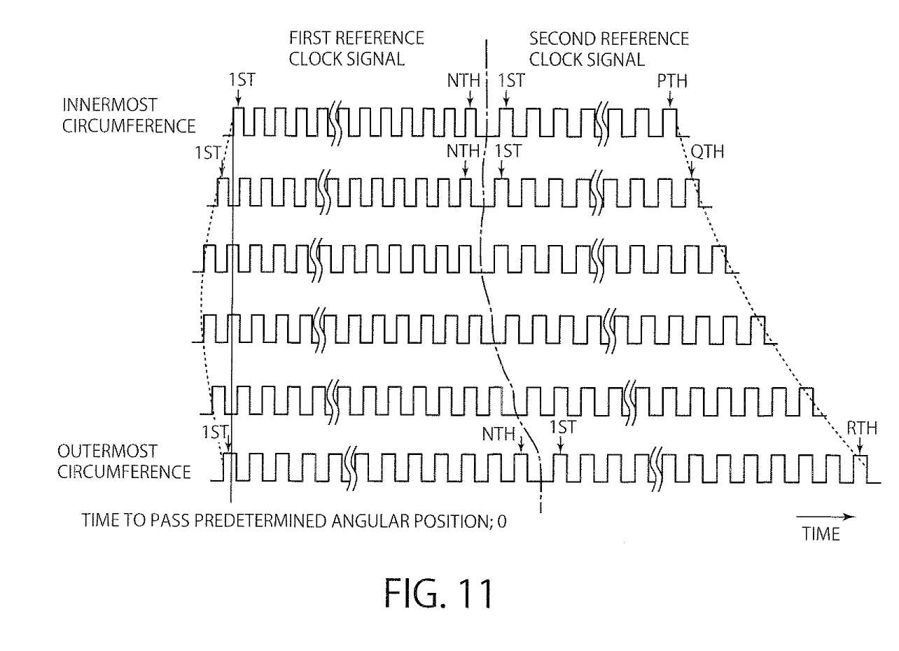

The control signal output from the control signal generation circuit 56A can be delayed or advanced in each rotation by the amount equivalent to each corresponding arm trajectory, to draw patterns corresponding to the arm trajectories. For example, as shown in FIG. 11, in a sector of the innermost circumference, the point where the first reference clock signal rises is set as the reference point. In the other circumference, the timing is shifted by the amount necessary for drawing the respective arm trajectories. FIG. 11 is a waveform chart of one sector, and, in FIG. 11, the first reference clock signal has a constant number of clocks but has cycles varying from the innermost circumference toward the outermost circumference, and the second reference clock signal has constant cycles but has the number of cycles varying from the innermost circumference toward the outermost circumference. Here, in the data regions, particularly, where guide dots to be used for controlling alignment of a self-organized material are to be drawn, delays according to the arm trajectories can not be added if the intervals between the guide dots are to be constant, regardless of the radius of each guide dot.

As described above, according to this embodiment, based on the first reference clock signal from the clock signal generation circuit 52, at least one of the deflection control signal and the blanking control signal for patterns in the servo regions is output from the control signal generation circuit 56A. Based on the second reference clock signal from the clock signal generation circuit 54, at least one of the deflection control signal and the blanking control signal for patterns in the data regions is output from the control signal generation circuit 56A. In this manner, patterns with circumferential lengths varying with the radius can be formed in the servo regions, and patterns with constant cycles (densities) that do not depend on the radius can be formed in the data regions. Accordingly, a high-recording-density magnetic recording medium (magnetic disk) can be manufactured.

### Second Embodiment

A stamper of a second embodiment is manufactured with the use of an original plate (photosensitive resin) on which patterns are drawn. The patterns are drawn by the method described in the first embodiment, and the method is performed with the electron beam irradiating apparatus of the first embodiment. The original plate is manufactured by drawing and development. These operations are performed with the electron beam irradiating apparatus of the first embodiment.

The photosensitive resin used in the electron beam irradiating can be either a positive resist or a negative resist, or can be either a chemically-amplified resist containing a material generating oxygen at the time of exposure (hereinafter referred to as an acid-generating material) or a chemically-unamplified resist. However, the positive resist of a chemically-unamplified type is notable, since such a resist has a high and stable sensitivity to electron beams, and also has a high resolution. Other than that, materials having main components such as a PMMA (polymethylmethacrylate) and a novolak resin. Such materials can have or can not have a resistance to dry etching. Exposure can be started from the inner circumferential side or from the outer circumferential side, or can be performed in several zones independent of one another.

### Third Embodiment

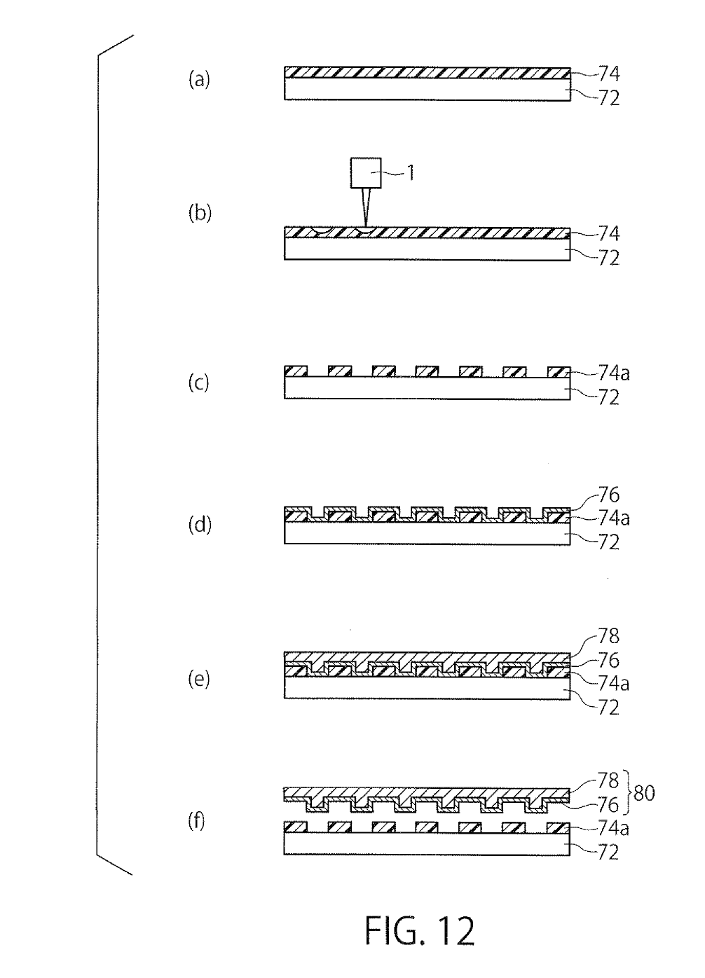

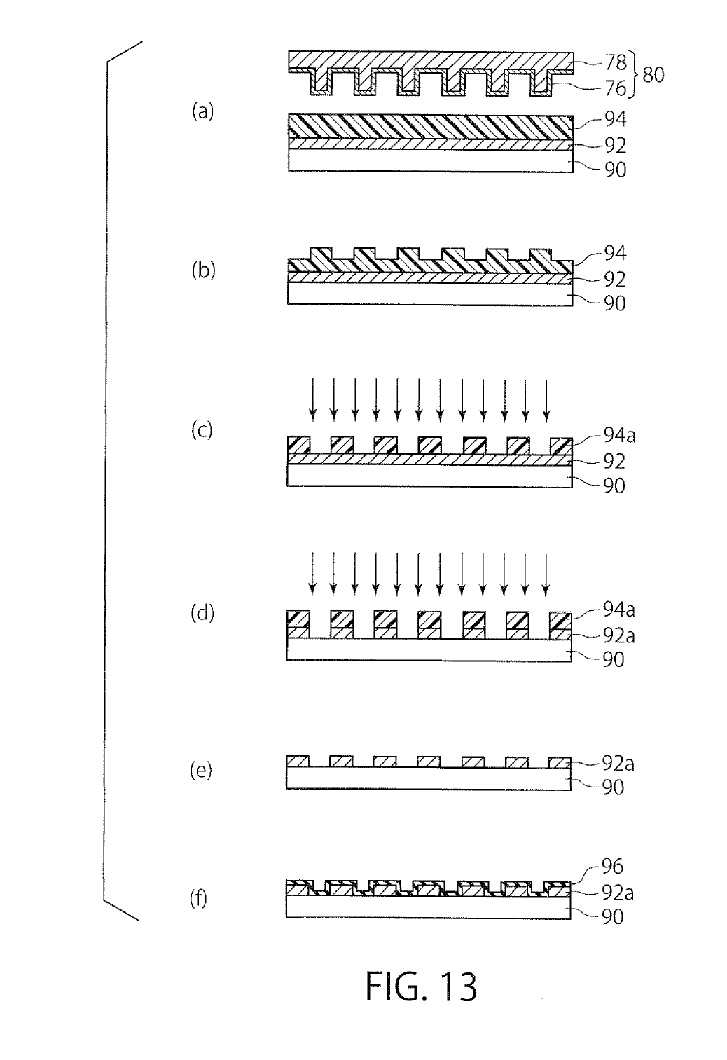

Referring now to FIGS. 12(a) through 13(f), a magnetic recording medium according to a third embodiment is described. The magnetic recording medium of this embodiment is a bit-patterned magnetic recording medium of a magnet-processed type (a magnetic bit-patterned medium). When such a magnetic recording medium is manufactured, the electron beam irradiating using a signal source described in the first embodiment is used in the exposure process. The following is a description of the procedures for manufacturing the magnetic recording medium of this embodiment.

A photosensitive resin (hereinafter referred to as a resist) 74 is first applied onto a substrate 72 (see FIG. 12(a)). The resist 74 is exposed to an electron beam by the electron beam irradiating apparatus 1 of the first embodiment, as shown in FIG. 12(b).

After that, the resist 74 is developed by a developer, to form a resist pattern 74a (a positive resist is shown in the drawings), and a resist original plate formed by the resist pattern 74a and the substrate 72 is manufactured (see FIG. 12(c)). It should be noted that post baking can be performed prior to the development of the resist 74.

A thin conductive film 76 is then formed on the resist pattern 74a of the resist original plate by Ni sputtering or the like (see FIG. 12(d)). At this point, the resist pattern 74a has such a film thickness as to maintain the shapes of the concave portions of the resist pattern 74a. After that, electrocasting is performed to fill the concave portions of the resist pattern 74a with a Ni film 78, and the film thickness of the Ni film 78 is adjusted to a desired film thickness (see FIG. 12(e)).

The Ni film 78 is then removed from the resist original plate formed of the resist pattern 74a and the substrate 72, and a stamper 80 formed of the conductive film 76 and the Ni film 78 is formed (see FIG. 12(f)). After that, to remove the resist remaining on the stamper 80, oxygen RIE (reactive ion etching) or the like is performed (not shown).

As shown in FIG. 13(a), a magnetic layer 92 to be a recording layer is formed on a substrate 90, and a resist 94 is applied onto the magnetic layer 92. In this manner, a magnetic recording medium substrate is prepared. Imprinting is then performed on the resist 94 applied onto the magnetic recording medium substrate with the use of the above-described stamper 80 (see FIG. 13(a)), and the pattern of the stamper 80 is transferred onto the resist 94 (see FIG. 13(b)).

As the pattern transferred onto the resist 94 serves as a mask, etching is performed on the resist 94 to form a resist pattern 94a (see FIG. 13(c)). After that, with the resist pattern 94a serving as a mask, ion milling is performed on the magnetic layer 92 (see FIG. 13(d)). The resist pattern 94a is then removed by dry etching or a chemical solution, and a discrete magnetic layer 92a is formed (see FIG. 13(e)).

A protection film 96 is then formed on the entire surface, to complete the magnetic recording medium (see FIG. 13(f)). It should be noted that the procedure for filling concave portions such as grooves with a nonmagnetic material can be carried out separately from the above described procedures.

The substrate on which a pattern is formed by the method of this embodiment is not particularly limited to the above, but a disk-like shape and is made of a silicon wafer, for example, can be used for the substrate. Here, notches or orientation flats can be formed in the disk. Other than that, a glass substrate, an Al-based alloy substrate, a ceramic substrate, a carbon substrate, a compound semiconductor substrate, or the like can be used for the substrate. As the glass substrate, amorphous glass or crystallized glass also can be used. The amorphous glass can be soda-lime glass, aluminosilicate glass, or the like. The crystallized glass can be lithium-based crystallized glass or the like. The ceramic substrate can be made of a sintered material containing a main component such as aluminum oxide, aluminum nitride, or silicon nitride, or can be made of a fiber-reinforced one of the above sintered materials. The compound semiconductor substrate can be made of GaAs, AlGaAs, or the like.

The shape of the magnetic recording medium can be a disk-like shape or a doughnut-like shape; these shapes are not limited by a system employed. The size of the magnetic recording medium is not also particularly limited by the system. However, the size of the magnetic recording medium can be 3.5 inches or smaller, so as to avoid an excessively long drawing time with an electron beam. Further, to avoid an excessively large pressing power to be used at the time of imprinting, the size of the magnetic recording medium can be 2.5 inches or smaller. Only one face or both faces of the magnetic recording medium can be used.

The inside of the magnetic recording medium is divided into concentric tracks formed like concentric rings. The tracks have sectors that are divided by a certain angle. The magnetic disk is attached to a spindle motor and is rotated. Various kinds of digital data are recorded and reproduced on and from the magnetic disk by a head. Therefore, while user data tracks are arranged in the circumferential direction, servo marks for controlling positions are arranged across the respective tracks. Each of the servo marks includes regions such as a preamble region, an address region in which track or sector number information is written, and a burst region for detecting the relative position of the head with respect to the tracks. Each of the servo marks can include a gap region as well as those regions.

To achieve a higher recording density, the track pitch is required to be narrower. In each one track, it is necessary to form nonmagnetic regions that partition the user data regions from one another, magnetic regions that serve as the data recording regions, address bits of the corresponding servo regions, burst marks, and the like. Therefore, drawing needs to be performed so as to form one track through several to several tens of rotations at the time of cutting. If the number of cutting rotations is small, the shape resolution becomes lower, and the pattern shapes cannot be accurately reflected. If the number of cutting rotations is large, the control signals become complicated and require high capacities. Therefore, one track can be formed through 6 to 36 rotations. Also, a number with many divisors is advantageous as the number of rotations, in view of the design of pattern arrangement.

Also, since the sensitivity of the film to be exposed is normally uniform in a plane, the linear velocity of the stage of the electron beam irradiating apparatus can be maintained at a constant value during rotations. For example, in a case where the tracks in a user data region are formed with a pitch of 200 nm, the cutting/track pitch should be 200/20=10 nm if one track is to be formed by cutting through 20 rotations. The cutting/track pitch can be equal to or smaller than the beam diameter, so as not to form an insufficiently exposed area or an undeveloped area.

As for the stage of the electron beam irradiating apparatus, the optical system for scanning an electron beam, and the signals for driving the stage and the optical system, at least the blanking points, the blanking signal, and the stage driving signal for controlling movement in the radial direction and the rotational direction need to be synchronized.

The stamper used for manufacturing the magnetic recording medium according to this embodiment can have a disk-like shape, a doughnut-like shape, or some other shape. The thickness of the stamper is 0.1 or more and 2 mm or less. If the stamper is too thin, a sufficient strength cannot be obtained. If the stamper is thicker than necessary, the electrocasting becomes time-consuming, and the film thickness difference becomes larger. The stamper is larger than the medium in size, but the size is not particularly limited by the system.

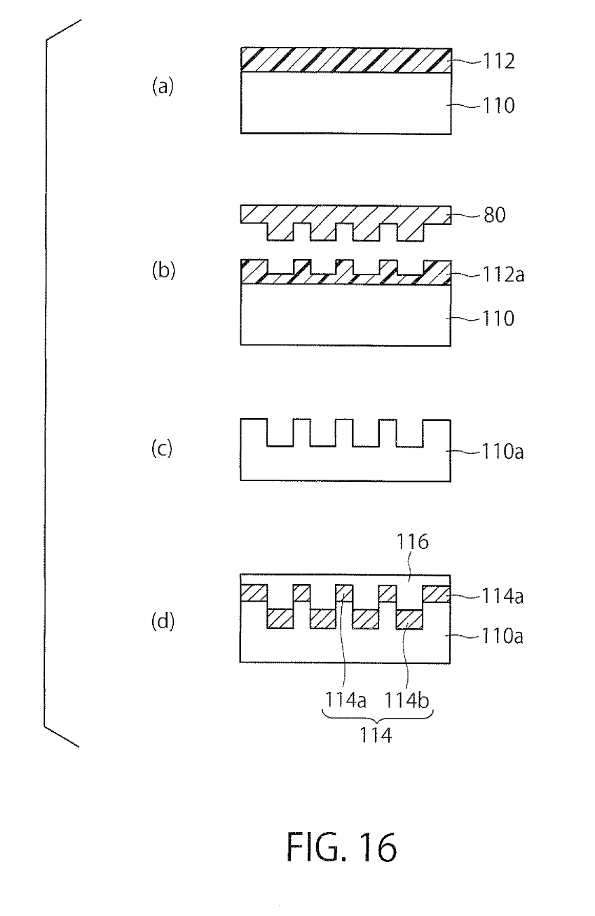

The magnetic recording medium according to the third embodiment is a bit-patterned magnetic recording medium of a magnet-processed type, as shown in FIG. 13(f). However, the magnetic recording medium according to the third embodiment can be a bit-patterned magnetic recording medium of a substrate-processed type, as shown in FIGS. 16(a) through 16(d), which will be described later. In the exposure process for manufacturing the discrete magnetic recording medium of a substrate-processed type, a stamper manufactured with the use of an original plate on which a pattern is drawn with the use of the electron beam irradiating apparatus described in the first embodiment is also used.

### Fourth Embodiment

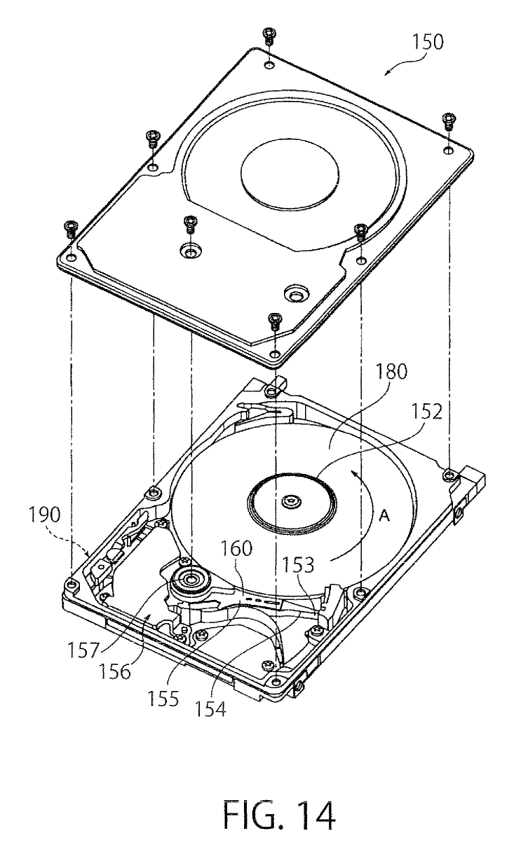

FIG. 14 shows a magnetic recording/reproducing device according to a fourth embodiment. As shown in FIG. 14, the magnetic recording/reproducing device 150 according to the fourth embodiment is a device using a rotary actuator. In FIG. 14, a recording medium disk 180 is mounted on a spindle motor 4, and is rotated in the direction of the arrow A by a motor (not shown) in response to a control signal from a drive control unit (not shown). The magnetic recording/reproducing device 150 according to this embodiment can include two or more recording medium disks 180.

When the recording medium disk 180 is rotated, the pressing force caused by a suspension 154 is balanced with the pressure generated in the medium facing surface (also referred to as the ABS) of a head slider, and the medium facing surface of the head slider is held at a predetermined floating distance from the surface of the recording medium disk 180.

The suspension 154 is connected to an end of an actuator arm 155 having a bobbin unit holding a drive coil (not shown). A voice coil motor 156 that is a kind of a linear motor is placed at the other end of the actuator arm 155. The voice coil motor 156 can be formed by a drive coil (not shown) wound around the bobbin unit of the actuator arm 155 and a magnetic circuit including a permanent magnet and a facing yoke that face each other, with the drive coil being sandwiched between the permanent magnet and the facing yoke.

The actuator arm 155 is held by ball bearings (not shown) placed at an upper portion and a lower portion of a bearing unit 157, and can be slidably rotated by the voice coil motor 156. As a result, the magnetic recording head can be moved to any position on the recording medium disk 180.

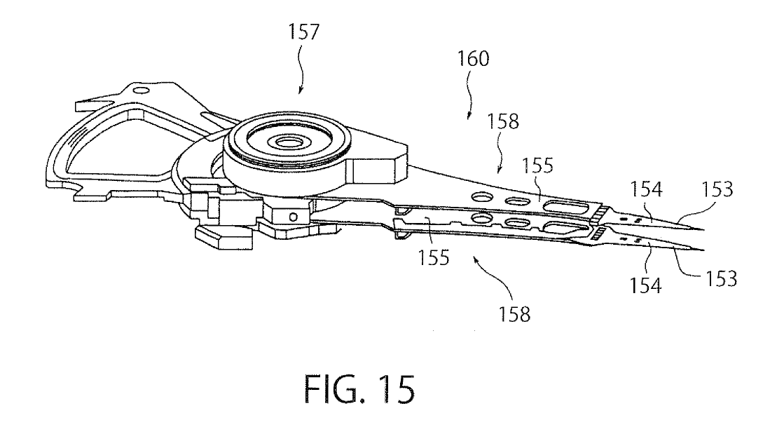

FIG. 15 shows an example structure of part of the magnetic recording device according to this embodiment, and is an enlarged perspective view of a magnetic head assembly 160 formed at the top portion of the actuator arm 155, seen from the disk side. As shown in FIG. 15, the magnetic head assembly 160 includes the bearing unit 157, a head gimbal assembly (hereinafter referred to as the HGA) 158 extending from the bearing nit 157, and a support frame 146 that extends from the bearing unit 157 in the opposite direction of the HGA 158 and supports the coil 147 of the voice coil motor 156. The HGA 158 includes the actuator arm 155 extending from the bearing unit 157, and the suspension 154 extending from the actuator arm 155.

A head slider 153 having the magnetic head is attached to the top end of the suspension 154.

That is, the magnetic head assembly 160 according to this embodiment includes the magnetic head, the suspension 154 having the magnetic head at one end, and the actuator arm 155 connected to the other end of the suspension 154.

The suspension 154 has signal reading writing lead wires (not shown), and the lead wires are electrically connected to respective electrodes of the magnetic recording head incorporated into the head slider 153. Electrode pads (not shown) are also formed on the magnetic head assembly 160.

A signal processing unit 190 (not shown) that performs signal writing and reading onto and from a magnetic recording medium with the use of the magnetic recording head is also provided. The signal processing unit 190 is placed on the back face side of the magnetic recording device 150 shown in FIG. 14, for example. The input/output wires of the signal processing unit 190 are connected to the electrode pads, to be electrically connected to the magnetic recording head.

### EXAMPLES

### Example 1

Referring now to FIGS. 12(a) through 13(f), a magnetic recording medium according to Example 1 is described.

An electron beam irradiating apparatus that had an electron gun emitter of a ZrO/W thermal field emission type and had an accelerating voltage of 100 kV was used. The electron gun emitter included an electron gun, a condenser lens, a blanking electrode, and a deflector.

Meanwhile, a resist was diluted three times with anisole, and was filtered by a 0.2-μm membrane filter. Spin coating was then performed on a 6-inch silicon wafer substrate 22 subjected to a HMDS treatment. After that, prebaking was performed at 200° C. for three minutes, to form a resist 74 of 0.05 μm in film thickness (see FIG. 12(a)).

The substrate 72 was transported to a predetermined position in the electron beam irradiating apparatus by the transporting unit in the system, and exposure was performed in a vacuum, to obtain a concentric circle pattern in the following conditions (see FIG. 12(b)).

Radius of the exposed portion: 13 to 31.5 mm

Number of sectors/number of tracks: 200

Number of bits based on the servo regions/number of sectors: 5000

Number of bits based on the servo regions/number of tracks: 5000×200=1 million

Cycles of the preamble signal generated with the use of the first reference clock signal/cycles of the first reference clock=10

Number of bits in the servo regions among the bits based on the servo regions/number of sectors: 500

Ratio between the servo regions and the data regions; servo regions:data regions=1:9

Data track pitch: 75 nm

Feed per revolution: 5 nm

Number of exposure rotations per data track: 15 rotations

Linear velocity: 1 m/s (constant)

Concentric circles were drawn, with the deflection intensity being gradually made higher during one revolution.

The address region contained a preamble pattern (equivalent to 200 bits), a burst pattern (equivalent to 200 bits), sector and track address patterns, and a gap pattern (equivalent to 100 bits). In the address region, the write data signal control unit 56 spontaneously generates the blanking signal so as to form a pattern with coded address numbers in each corresponding position. Each sector started with a signal for drawing the preamble.

When the first rising edge of the first reference clock signal generated from the clock signal generation circuit 52 in a rotation was recognized, a write data signal for drawing the preamble was output from the control signal generation circuit 56A. When the 2501st rising edge of the first reference clock signal was recognized, a write data signal for drawing the data regions was output.

The data region drawing signal then conducted drawing by supplying a 75-ns cycle blanking signal from the control signal generation circuit 56A, until the 24999th rising edge of the first reference clock signal was recognized.

After that, when the 1+25000×mth (m=1, 2, . . . , 199) rising edge of the first reference clock signal in the rotation was recognized, a signal for drawing the preamble was output. When the 2501+25000×mth rising edge of the first reference clock signal was recognized, a signal for drawing the data regions was output. The data region drawing signal then conducted drawing of one track by repetitively supplying a 75-ns cycle blanking signal from the control signal generation circuit 56A, until the 24999+25000×mth rising edge of the first reference clock signal was recognized. This operation was repeated for the respective rotations.

After that, among the exposure rotations per data track, drawing was performed only for six rotations, and was not performed for nine rotations. Meanwhile, drawing was performed in accordance with the pattern for each rotation in the servo regions.

After the exposure, the silicon wafer substrate 72 was immersed in a developer for 30 seconds, and was developed. The silicon wafer substrate 72 was then immersed in a rinse agent for 30 seconds, and was rinsed. The silicon wafer substrate 72 was then dried by an air blower. In this manner, a resist original plate with concavities and convexities was manufactured (see FIG. 12(c)).

A conductive film 76 was formed on the resist original plate by a sputtering technique. Pure nickel was used as the target. Vacuuming was performed until 8×10⁻³ Pa was achieved. After that, sputtering was performed for 40 seconds by applying a DC power of 400 W in a chamber that was adjusted at 1 Pa through introduction of an argon gas. In this manner, the 30-nm thick conductive film 76 was obtained (see FIG. 12(d)).

With the use of a nickel sulfamate plating solution, electrocasting was performed for 90 minutes on the resist original plate having the conductive film 76 formed thereon (see FIG. 12(e)). The electrocasting bath conditions were as follows.

Nickel sulfamate: 600 g/L

Boric acid: 40 g/L

Surfactant (sodium lauryl sulfate): 0.15 g/L

Solution temperature: 55° C.

P.H: 4.0

Current density: 20 A/dm²

The thickness of the electrocast film 78 was 300 m. After that, the electrocast film 78 was removed from the resist original plate. As a result, a stamper 80 having the conductive film 76, the electrocast film 78, and a resist residue was obtained (see FIG. 12(f)).

The resist residue was then removed by an oxygen plasma ashing technique. The oxygen plasma ashing was performed for 20 minutes at 100 W in a chamber into which an oxygen gas was introduced at 100 ml/min and was adjusted to a 4-Pa vacuum (not shown). In this manner, the father stamper 80 having the conductive film 76 and the electrocast film 78 was obtained. After that, unnecessary portions of the obtained stamper 80 were stamped out with a metal cutter, and the stamper 80 for imprinting was formed.

After the stamper 80 was subjected to ultrasonic cleaning with acetone for 15 minutes, the stamper 80 was immersed for 30 minutes in a solution in which fluoroalkylsilane [CF₃(CF₂)₇CH₂CH₂Si(OMe)₃] was diluted to 5% with ethanol, so as to improve the mold release properties at the time of imprinting. After the solution was blown off by a blower, the stamper 80 was subjected to 1-hour annealing at 120° C.

Meanwhile, as a substrate to be processed, a magnetic recording layer 92 was formed on a 0.85-inch, doughnut-like glass substrate 90 by a sputtering technique, and the recording layer 92 was coated with a novolak-based resist 94 by spin coating at 3800 rpm (see FIG. 13(a)). Pressing was then performed with the above described stamper 80 for 1 minute at 2000 bar, to transfer the pattern from the stamper 80 onto the resist 94 (see FIG. 13(b)). The resist 94 having the pattern transferred thereunto was exposed to UV rays for 5 minutes, followed by 30-minute heating at 160° C.

With the use of an ICP (inductively-coupled plasma) etching device, oxygen RIE was performed at an etching pressure of 2 mTorr on the substrate 90 subjected to imprinting in the above manner, to form an etching mask 94a (see FIG. 13(c)). With the use of the etching mask 94a, etching was performed on the recording layer 92 by Ar ion milling (see FIG. 13(d)). After the etching on the recording layer 92, to remove the etching mask 94a made of a resist, oxygen RIE was performed at 400 W and 1 Torr (see FIG. 13(e)). After the etching mask 94a was removed, a DLC (Diamond-Like Carbon) film having a thickness of 3 nm was formed as a protection film 96 by CVD (chemical vapor deposition) (see FIG. 13(f)). Further, a lubricant agent was applied to form a 1-nm thick film by a dipping technique.

The medium on which imprinting and processing were performed in the above manner was incorporated into a magnetic recording device, and signals were detected. As a result, good servo signals and 75-nm pitch data region signals were obtained.

### Example 2

Referring now to FIGS. 16(a) through 16(d), a method of manufacturing a magnetic recording medium according to Example is described. The magnetic recording medium to be manufactured by the manufacture method of this example is a magnetic recording medium of a substrate-processed type.

First, an imprint stamper is manufactured by the same technique as the technique illustrated in FIGS. 12(a) through 12(f), Particularly, the procedure illustrated in FIG. 12(b) is the same as the drawing technique described in the first embodiment.

A processed substrate having concavities and convexities is then manufactured by the following imprint lithography technique. As shown in FIG. 16(a), a resist 112 for imprinting is applied onto a substrate 110. As shown in FIG. 16(b), the stamper 80 is positioned to face the resist 112 on the substrate 110, and the stamper 80 is pressed against the resist 112 to transfer the convex portion pattern formed in the surface of the stamper 80 onto the surface of the resist 112. After that, the stamper 80 is removed. In this manner, the resist 112 turns into a resist pattern 112a having a concavity and convexity pattern formed thereon (see FIG. 16(b)).

With the resist pattern 112a serving as a mask, etching is performed on the substrate 110, to obtain a substrate 110a having a concavity and convexity pattern formed thereon. After that, the resist pattern 112a is removed (see FIG. 16(c)).

As shown in FIG. 16(d), a magnetic film 114 made of a material suitable for vertical recording is formed on the substrate 110a. At this point, the portions of the magnetic film formed on the convex portions of the substrate 110a turn into convex magnetic portions 114a, and the portions of the magnetic film formed in the concave portions of the substrate 110a turn into concave magnetic portions 114b. Here, the magnetic film 114 is a stack film of a soft magnetic underlayer and a ferromagnetic recording layer. A protection film 116 made of carbon is further placed on the magnetic film 114, and a lubricant film is further applied onto the protection film 116. In this manner, a magnetic recording medium is completed.

A medium on which imprinting and processing were performed in the above manner was incorporated into a magnetic recording device, and signals were detected. As a result, a good burst signal was obtained, and head position control was performed appropriately.

As described so far, bit-patterned magnetic recording media with high recording densities can be manufactured.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. An electron beam irradiating apparatus comprising:
a rotation mechanism configured to rotate a stage which holds a substrate, a photosensitive resin film being formed on the substrate;
a movement mechanism configured to move the stage in a horizontal direction;
an electron gun configured to emit an electron beam onto the photosensitive resin film;
a deflector configured to perform blanking or deflecting of the electron beam emitted from the electron gun, the blanking being performed based on a blanking control signal, the deflecting being performed based on a deflection control signal, or blanking and deflecting being performed based on the blanking control signal and the deflection control signal;
a first clock signal generation circuit configured to generate a first reference clock signal having cycles which vary with a drawing radial position on the stage;
a second clock signal generation circuit configured to generate a second reference clock signal having cycles which are independent of the first reference clock signal; and
a control signal generation circuit configured to generate a first control signal that is at least one of the blanking control signal and the deflection control signal, based on the first reference clock signal and the second reference clock signal.

2. The apparatus according to claim 1, wherein the second reference clock signal has constant cycles, regardless of the drawing radial position.

3. The apparatus according to claim 1, wherein,
when the control signal generation circuit executes an output of the blanking control signal and the deflection control signal based on the second reference clock signal, the output starts from a first count value of the number of clocks of the first reference clock signal, and ends at a second count value that is larger than the first count value.

4. The apparatus according to claim 1, wherein,
when the control signal generation circuit executes an output the blanking control signal and the deflection control signal based on the second reference clock signal, the output starts from a third count value and ends at a fourth count value that is larger than the third count value, the third count value being of the number of pulses of a second control signal that is generated based on the first reference clock signal and is used for drawing a pattern of a preamble region.

5. The apparatus according to claim 1, wherein the control signal generation circuit does not output the blanking control signal and the deflection control signal based on the second reference clock signal, while a determination signal for defining a range of servo regions is being generated based on the first reference clock signal and is being output.

6. An electron beam irradiating method for drawing a pattern by emitting an electron beam onto a photosensitive resin film with the use of an electron beam irradiating apparatus including: a rotation mechanism rotating a stage which holds a substrate, the photosensitive resin film being formed; a movement mechanism moving the stage in a horizontal direction; an electron gun emitting an electron beam onto the photosensitive resin film; and a deflector blanking or deflecting the electron beam emitted from the electron gun, the blanking being performed based on a blanking control signal, the deflection being performed based on a deflection control signal, or blanking and deflecting the electron beam emitted from the electron gun based on the blanking control signal and the deflection control signal,
the electron beam irradiating method comprising:
generating a first reference clock signal having cycles which vary at least with a drawing radial position on the stage;
generating a second reference clock signal having cycles which are independent of the first reference clock signal; and
generating a first control signal that is at least one of the blanking control signal and the deflection control signal, based on the first reference clock signal and the second reference clock signal.

7. The method according to claim 6, wherein the second reference clock signal has constant cycles, regardless of the drawing radial position.

8. The method according to claim 6, wherein,
when an output of the blanking control signal and the deflection control signal are executed by the second reference clock signal, the output starts from a first count value of the number of clocks of the first reference clock signal, and ends at a second count value that is larger than the first count value.

9. The method according to claim 6, wherein,
when an output of the blanking control signal and the deflection control signal are executed by the second reference clock signal, the outputting starts from a third count value and ends at a fourth count value that is larger than the third count value, the third count value being of the number of pulses of a second control signal that is generated based on the first reference clock signal and is used for drawing a pattern of a preamble region.

10. The method according to claim 6, wherein the blanking control signal and the deflection control signal are not output based on the second reference clock signal, while a determination signal for defining a range of servo regions is being generated based on the first reference clock signal and is being output.
